(19) United States
(12) Patent Application Publication
(10) Pub. No.: US 2025/0288115 A1
(43) Pub. Date: Sep. 18, 2025

(54) FOAM-IN-PLACE ELECTRO-THERMAL CONVERSION DEVICE

(71) Applicant: Promethient, Inc., Traverse City, MI (US)

(72) Inventors: Zachary Cauchy, Kingsley, MI (US); Jordan Colvin, Traverse City, MI (US); Dan Pomeroy, Traverse City, MI (US); Todd Fletemier, Kalkaska, MI (US)

(21) Appl. No.: 19/081,868

(22) Filed: Mar. 17, 2025

Related U.S. Application Data
(60) Provisional application No. 63/565,712, filed on Mar. 15, 2024.

(51) Int. Cl. A47C 7/74; A47C 7/20; B29C 44/12; B29L 31/00; B29L 31/58

(52) U.S. Cl. CPC A47C 7/744; A47C 7/20; A47C 7/748; B29C 44/1271; B29L 2031/58; B29L 2031/779

(57) ABSTRACT

A seating system includes a seat and a cushioned thermal module for the seat. The cushioned thermal module includes an electro-thermal conversion device that moves heat to or from a conductive surface in response to applying a low voltage current. A composite structure having a graphene material is thermally coupled with the conductive surface of the electro-thermal conversion device. A foam structure is molded to encase the electro-thermal conversion device and define a seat support surface. The composite structure may be partially disposed over the seat support surface, such that the composite structure operates to conductively transfers heat between the electro-thermal conversion device and a seat cover disposed over the seat support surface.

### CROSS-REFERENCE TO RELATED APPLICATION

This application claims the benefit and priority under 35 U.S.C. § 119 (e) of U.S. provisional application Ser. No. 63/565,712, filed on Mar. 15, 2024, the content of which is incorporated herein by reference in its entirety.

### TECHNICAL FIELD

The present disclosure relates to heating and cooling systems and devices and more specifically to thermally conductive structures disposed in foam and used to conductively transfer heat to and from an object, such as flexible thermally conductive structures that directly or indirectly interface with a person's body.

### BACKGROUND

The use of thermoelectric devices to heat and cool objects is well known, including the use of these solid state devices to heat and cool a person. The efficiency of the heat transfer, however, between a person and a thermoelectric device is often severely diminished by layers of insulating materials that are provided to comfortably contact the person's body.

In recent advancements, thin sheets and strips of graphene have been implemented for use with thermoelectric devices to utilize its high thermal conductivity to improve heat transfer between a person and the thermoelectric device, such as described in U.S. Pat. No. 11,033,058. Moreover, objects such as seat backs and cushions often include foam structures or the like to fill a seat interior and create a comfortable seating surface for a person. Integrating a thermoelectric device into a seat interior to provide a system for heating and cooling a person using the seat can require reconfiguration of the existing seat interior, such as by cutting away portions of the foam structure, to add the thermoelectric device inside the foam structure.

### SUMMARY

The present disclosure provides a cushioned thermal module for conductively heating and/or cooling, such as for various implementations in furniture and seats of all types, including for various types of vehicles, child seats, aviation, marine, motorcycles, powersports, and the like. The cushioned thermal module or system may include an electro-thermal conversion device that is configured to electrically generate heating and/or cooling. The electro-thermal conversion device may move heat to or from a conductive surface in response to applying a low voltage current from a power source to the electro-thermal conversion device. The module and systems may include a composite structure that is configured to conductively transfer heat between the electro-thermal conversion device and the seat support surface defined by the foam structure. In some examples, the composite structure may be a graphene material and may be at least partially disposed over the seat support surface. The electro-thermal conversion device may be encased in the foam structure for positioning in the seat, such that a seat cover may be disposed over the seat support surface and the composite structure to from the user support surface of the seat.

In some implementations, the composite structure includes a flexible panel that has a first portion disposed over the seat support surface and a second portion suspended inside the foam structure. In some examples, the graphene material flexibly extends between the first portion and the second portion of the flexible panel. For instance, the second portion of the flexible panel may be thermally coupled with the conductive surface, such as via a heat transfer block. In some examples, the graphene material may be positioned on an outer surface of the foam structure. In other examples, the graphene material may be suspended inside the foam structure.

In some examples, a barrier film is disposed over the seat support surface defined by the foam structure, so as to prevent the foam structure from covering a least a portion of the composite structure and its graphene material. The composite structure, in some implementations, extends through an opening in the barrier film to define an exposed portion that is positioned outside the foam structure. The barrier film may be a flexible sheet material that is air permeable and configured to resist the passage of liquid foam during the formation of the foam structure.

In some examples, the foam structure may be molded, such as via an injection molding or open molding process, to surround the electro-thermal conversion device. The foam structure may be sized and shaped to fit or fill a seat back or a seat cushion to provide a user support surface for the seat system. In some implementations, a protective cover surrounds at least a portion of the electro-thermal conversion device and is located between the foam structure and the electro-thermal conversion device. Further, in some instances, the protective cover surrounds a blower and a heat sink, where the blower is configured to direct air over the heat sink. The heat sink may be thermally coupled to the electro-thermal conversion device to disperse heat. The foam structure may, in some examples, include an air channel from an outer surface of the foam structure to the protective cover, where the air channel may be generally aligned with an inlet vent and/or an outlet vent of the protective cover. The blower may be configured to direct the air from the inlet over fins of the heat sink to dissipate heat from the electro-thermal conversion device.

In further examples, the foam structure may include multiple sections of various densities. Accordingly, sections of less density may be placed near a surface of which a user interfaces to provide more movement and cushioning. Sections of more density may be placed near the electro-thermal conversion device to provide less movement and more protection and stability around the device.

In some examples, a seating system may be provided where the electro-thermal conversion device is provided in either a seat back or a seat cushion. Due to the configuration of the seat back or the seat cushion, more than one the electro-thermal conversion device may be placed within the seat back or seat cushion. When more than one the electro-thermal conversion device is positioned in a seat back or a seat cushion, the electro-thermal conversion devices may be configured to operate dependently such that one controller operates both. In other examples, the electro-thermal conversion devices may be configured to operate independently.

According to another aspect of the disclosure, a seating system is provided that has a seat frame. A cushioned thermal module is provided and supported by the seat frame. The cushioned thermal module includes an electro-thermal conversion device that is configured to move heat to or from a conductive surface in response to applying a low voltage current. A foam structure encases the electro-thermal conversion device and defines a seat support surface. A graphene structure is thermally coupled with the conductive surface of the electro-thermal conversion device and is at least partially disposed over the seat support surface. A seat cover may be disposed over the seat surface and the graphene structure to define a user support surface. The graphene structure is configured to conductively transfer heat between the electro-thermal conversion device and the seat cover.

In some implementations, the seat frame includes a seat pan that supports the cushioned thermal module as a seat cushion. In some examples, the seat frame includes a seat back that supports a second cushioned thermal module as a back cushion. The first cushioned thermal module and the second cushioned thermal module may be connected to a common controller and may be configured to operate independently.

According to another aspect of the disclosure, a method is provided for forming a cushioned thermal module for a seat. The method includes providing an electro-thermal conversion device that is configured to move heat to or from a conductive surface in response to applying a low voltage current. A first portion of a flexible graphene structure may be positioned at a bottom surface of a mold cavity. A second portion of the flexible graphene structure may be thermally coupled with the conductive surface of the electro-thermal conversion device. The electro-thermal conversion device is suspended above the bottom surface of the mold cavity. A liquid foam mixture is poured into the mold cavity to at least partially encase the electro-thermal conversion device. The liquid foam mixture then cures in the mold cavity to form a foam structure that defines a seat support surface with the first portion of the flexible graphene structure at least partially disposed over the seat support surface.

The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is a side view of a seat structure having a cushioned thermal module.

FIG. 2 is a cross-sectional side view of a cushioned thermal module.

FIG. 2A is a cross-sectional side view of an additional example of a cushioned thermal module showing a barrier film separating a portion of the conductive structure from the foam structure.

FIG. 2B is a cross-sectional side view of an additional example of a cushioned thermal module showing a barrier film separating the conductive structure from the foam structure.

FIG. 3 is an exploded top perspective view of a cushioned thermal module having an electro-thermal conversion device and a foam structure.

FIG. 4 is an exploded bottom perspective view of the cushioned thermal module shown in FIG. 3.

FIG. 5 is a partial side view of the electro-thermal conversion device shown in FIG. 3.

FIG. 6 is a bottom perspective view of the electro-thermal conversion device shown in FIG. 3.

FIG. 7 is an exploded top perspective view the electro-thermal conversion device shown in FIG. 3.

FIG. 8 is top view of an in a foam mold.

FIG. 9 is a top perspective view of the electro-thermal conversion device in the foam mold shown in FIG. 8 with liquid foam covering the conductive structure.

FIG. 10 is a top view of a cushioned thermal module showing the conductive structure formed in the foam structure.

FIG. 11 is a bottom view of the cushioned thermal module shown in FIG. 10 having the heat sink exposed from the foam structure.

FIG. 12 is a top view of an additional example of a cushioned thermal module showing the conductive structure formed in the foam structure.

FIG. 13 is a close up view of the conductive structure formed in the foam structure shown at section XIII in FIG. 12.

FIG. 14A is a top view of the cushioned thermal module shown in FIG. 2A.

FIG. 14B is a top view of the cushioned thermal module shown in FIG. 2B.

FIG. 15A is a schematic side view of an example of a system having an electro-thermal conversion device and a foam structure.

FIG. 15B is a schematic side view another example of a system having an electro-thermal conversion device and a foam structure.

FIG. 15C is a schematic view of another example of a system having an electro-thermal conversion device and a foam structure.

FIG. 16 is a front view of another example of a seat structure having a cushioned thermal module.

FIG. 17 is a top view of the seat structure shown in FIG. 16.

Like reference numerals indicate like parts throughout the drawings.

### DETAILED DESCRIPTION

Referring now to the drawings and the illustrative examples depicted therein, a cushioned thermal module 10 may be incorporated into a seating system to use a heating and/or cooling source to provide or otherwise transfer thermal energy in the system to conductively heat or cool an occupant of the seating system when the occupant is in contact with the seat surface 12. In additional examples, the heating or cooling device may be incorporated in other conductive heating or cooling applications, such as garments, furniture, and seats of all types, including seats for various types of vehicles, child seats, industrial equipment, aviation, marine, railcars, powersports, motorcycles, and the like. Moreover, in addition to conductively heating or cooling the body of a person, the heating or cooling device may be configured to conductively heat or cool other objects, such as electronics, food, beverages, medicines, animals, or the like. Accordingly, as used herein, the term “body” means a living person, animal, plant, or inanimate object, such as a device, a container, or the like.

The heating or cooling source of the device disclosed herein is an electro-thermal conversion device 14. The electro-thermal conversion device 14 may be any type of solid-state thermal device that converts electrical energy to thermal energy (heating or cooling), such as a thermoelectric device or an electrical resistance heater, like a PTC heating element or a similar device. For example, as shown in the drawings, the electro-thermal conversion device 14 is a thermoelectric module that is a solid-state device also commonly referred to as a thermoelectric device, thermoelectric heat pump, or Peltier cell. The electro-thermal conversion device 14 is configured to move heat to or from a conductive surface thereof in response to low voltage current applied to the electro-thermal conversion device 14. The illustrated example of the electro-thermal conversion device 14 includes an array of p-type and n-type semiconductor elements disposed electrically in series and thermally in parallel between two plates 16a, 16b, such as ceramic plates. The semiconductors are comprised of bismuth telluride, although in other examples they may be made of different types of materials. When low voltage power in the form of direct current passes through the p-type to the n-type semiconductor, a temperature drop is experienced at the junction according to the Peltier Effect and produces a cold side at one of the plates and a hot side at the other plate. For example, the thermoelectric device may be configured to operate efficiently from 10 to 16 V DC, so as to be compatible with common vehicle electrical system and other low-voltage applications. The power may be provided by one or many different sources, such as batteries, automotive and marine DC systems, AC/DC converters, and linear and switched DC power supplies. Further, by reversing polarity of the power input to the thermoelectric device, the Peltier Effect also reverses so that the hot side plate would become the cold side plate and the cold side plate would become the hot side plate.

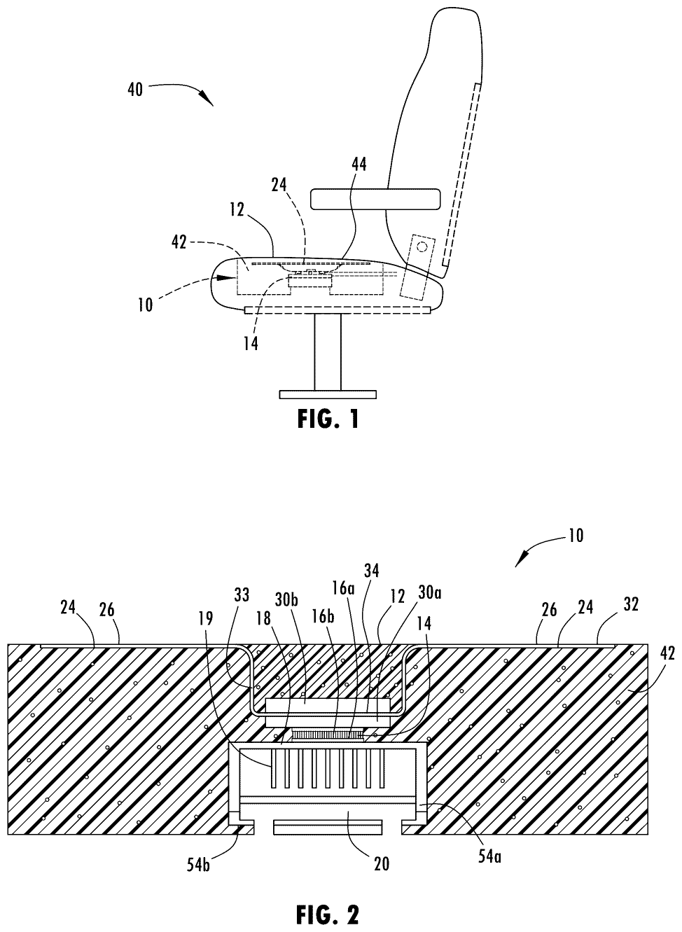

Referring to FIG. 1, the cushioned thermal module 10 is provided in a seat system 40 and incapsulated in a foam structure 42. The foam structure 42 is configured as a support for seat system 40, such that the foam structure 42 may be provided under a seat surface 12, for example, at a seat cushion, seat back, or bench. The foam structure 42 may also act as a support for a seat occupant, providing a soft surface for the occupant to sit on or against without sitting directly on portions of the system module 10. An outer cover 44 or seat cover, such as a fabric or non-fabric seat upholstery material or cover stock, is supported by the foam structure 42. In a thermoelectrically cooled seat system, the graphene sheet material 26 is usually many degrees cooler than the ambient environment. This is because the graphene sheet material must be much cooler than the seat occupant to provide a noticeable temperature differential and therefore, the thermal potential, to effectively remove heat from the seat occupant. The seat cover 44 provides a thermal resistance that must be overcome by a temperature differential between the occupant and the composite structure extending from the electro-thermal conversion device. In addition, other components of the seat system can indirectly add some heat into the system where the electro-thermal conversion device can also remove at least some of the heat in these additional components.

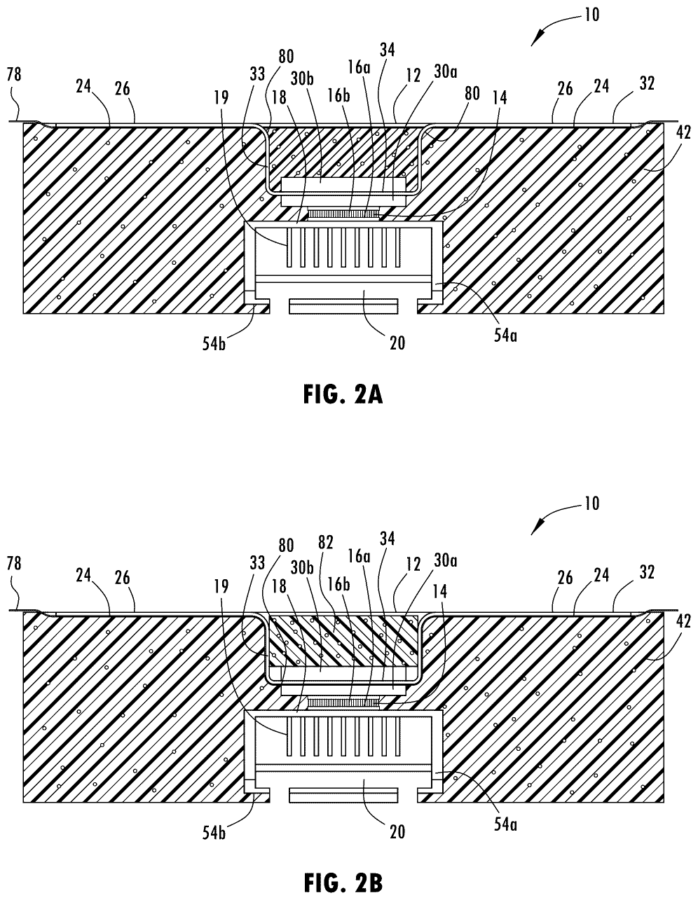

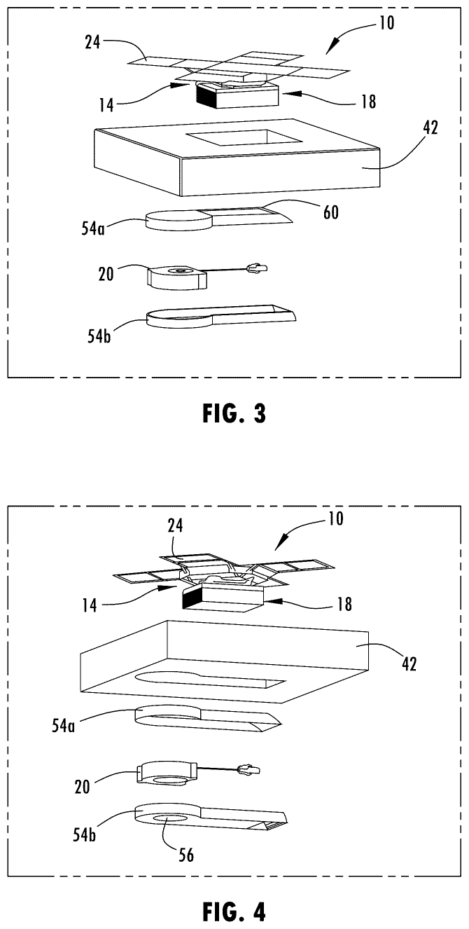

As illustrated in FIGS. 2-7, the electro-thermal conversion device 14 is shown as a thermoelectric device that operates with electrical current, which may be provided to an upper plate 16a as a ‘cold side’ and to a lower plate 16b as a ‘hot side’. To disperse heat transferred from the hot side, the lower plate 16b includes a heat sink 18 that disperses the heat to the environment, such as by dispersing the heat over the surface area of the fins 19 of the heat sink 18. The heat on the heat sink 18 may by dissipated quickly into the surrounding environment by movement of air over the fins 19 of the heat sink 18, for example, via a blower or fan 20 (FIGS. 3 and 4). It is contemplated that additional examples may include alternative means for dispersing heat or cold from the lower plate or side of the thermoelectric module that is directed away from the occupant or object being heated or cooled. The blower 20 may be encapsulated in a protective cover having an upper cover 54a and a lower cover 54b.

As further shown in FIGS. 2-7, a conductive surface on the upper plate 16a of the electro-thermal conversion device 14 operates to absorb heat and provide a cooling temperature effect. The conductive surface may be thermally coupled with a thermally conductive structure that conductively transfers the heated or cooled temperature effect provided by the electro-thermal conversion device 14 to the seat occupant and spreads or disperses the heated or cooled temperature effect over the surface are that directly or indirectly interfaced with the seat occupant, thereby distributing the cooling effect to a larger area than the conductive surface of the electro-thermal conversion device itself. The thermally conductive structure 24 shown in FIG. 1 is a composite structure 24 that is coupled thermally with the electro-thermal conversion device 14 and extends from the electro-thermal conversion device 14 toward the seat surface 12.

The composite structure 24 may include carbon-based materials, such as graphite, to effectively spread the temperature difference out over a wider distribution area across the surface of the seat. The composite structure 24, for example, may include graphene sheet material 26. Graphene, pyrolytic graphite, and highly oriented dense graphite are shown to be highly thermally conductive materials. Thermal conductivity of the sheet material can generally range from 500 to 200 W/mk or more in the plane of the sheet. In comparison, other high thermal conductivity metals have thermal conductivities that generally fall below this range.

Referring again to FIGS. 2-7, the graphene sheet material 26 is thermally coupled with the conductive surface of the electro-thermal conversion device 14. To provide conductive material for the thermal coupling, a heat transfer block 30 is provided with an upper thermal transfer block 30a located on top of the graphene sheet material 26 and a lower thermal transfer block 30b located below the graphene sheet material 26 and in contact with the conductive surface of the electro-thermal conversion device 14. The upper and lower thermal transfer blocks 30 act to sandwich the graphene sheet material 26 therebetween to form a thermally conductive coupling.

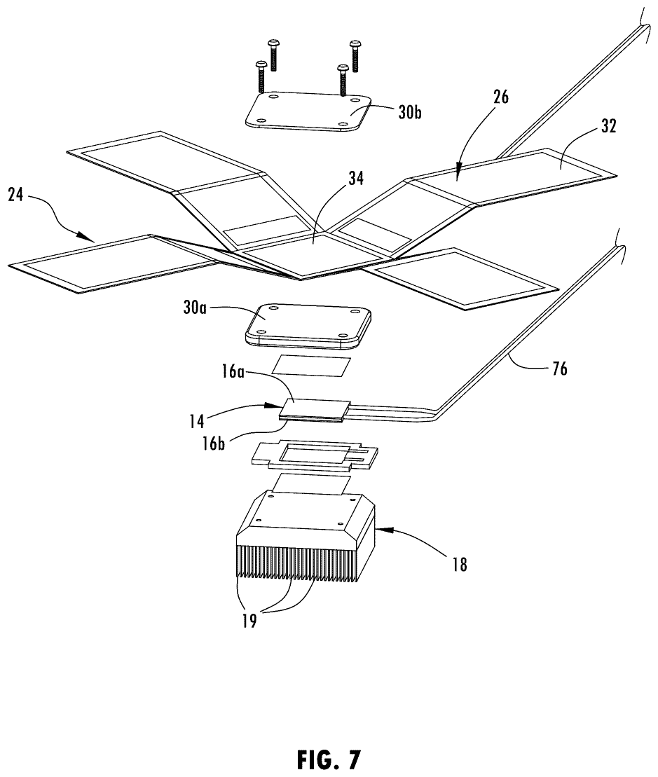

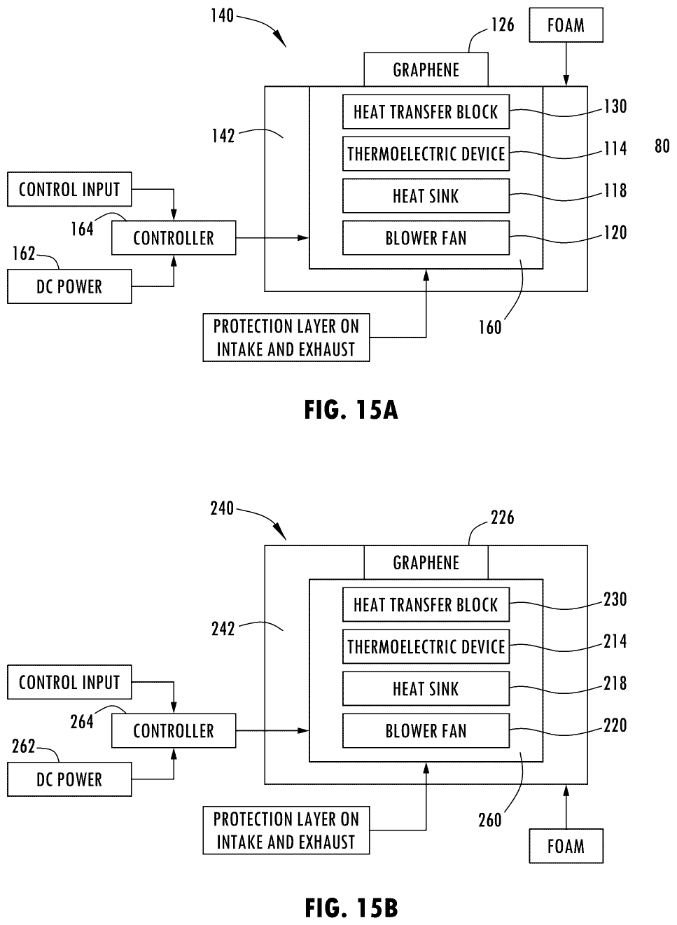

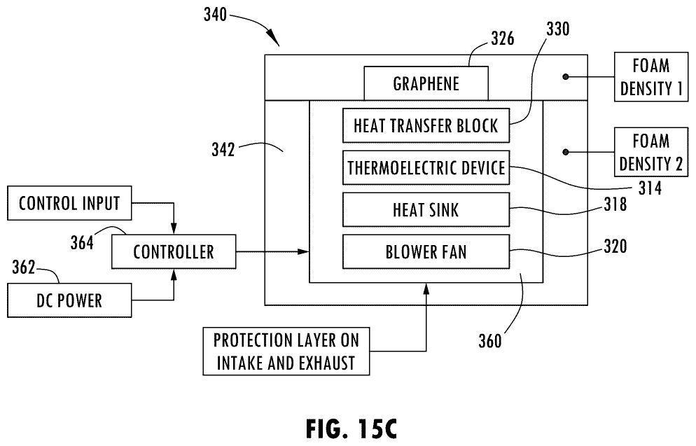

Referring to FIGS. 3 and 4, the foam structure 42 incapsulates the electro-thermal conversion device 14, and may also encapsulate the heat sink 18, the thermal transfer blocks 30a, 30b, and the graphene 26, such as shown in FIG. 2. The foam structure 42 may also encapsulate the blower 20, which is positioned to move air over the fins 19 of the heat sink to dissipate heat, such as shown in FIGS. 3 and 4. Alternatively, as illustrated in FIG. 11, the foam structure 42 may be relatively thin so that the heat sink 18 remains exposed from the foam structure. As also shown in FIGS. 7, 8, and 11, an electrical wire 76 may extend from the heating and cooling device 10 and through the foam structure 42, such that the wire 76 may be provided to an electrical system for communication with a power source 162 and a controller 164, as shown in FIG. 15A.

As further shown in FIGS. 3 and 4, a protective cover 54a, 54b substantially covers the heat sink 18 attached to the electro-thermal conversion device 14 and the blower 20. For example, the protective cover 54a, 54b surrounds the blower 20 to prevent foam or other debris from entering the blower 20. For example, the protective cover may include a top cover 54a and a bottom cover 54b which engage to surround the blower 20. The bottom cover 54b includes an inlet vent 56, which is open to the blower 20 to allow airflow into the blower 20 through the cover. The bottom cover 54b also includes an outlet vent 58 to allow hot air to exit away from the heat sink 18. The top cover 54a may be attached in a sealed manner to the bottom cover, sealing the air passage therein. In some examples, the protective cover may be partially encapsulated in the foam structure such that the inlet and outlet vents are positioned in line with a foam edge such that the foam does not cover or block the vents. In other examples, the protective cover may be fully encapsulated by the foam, such that an air channel or duct is provided from the inlet and outlet vents to an opening in the foam providing an airway. The protective cover also includes a device opening 60 configured to fit the heat sink 18 and electro-thermal conversion device 14, so as to substantially surround the thermal engine, including the electro-thermal conversion device 14. The protective cover may be secured to the thermal module 10 via screws. In examples, screws may secure the protective cover to the thermal module 10 by passing through and securing through the heat sink 18, the transfer plates 30, and the graphene 26. In this configuration, the fans 19 of the heat sink 18 are provided within the protection case 54a, 54b and in line with the airstream from the blower 20, such that the air may help dissipate the exhaust air. The electro-thermal conversion device 14 is also protected from debris or other potentially damaging particulate.

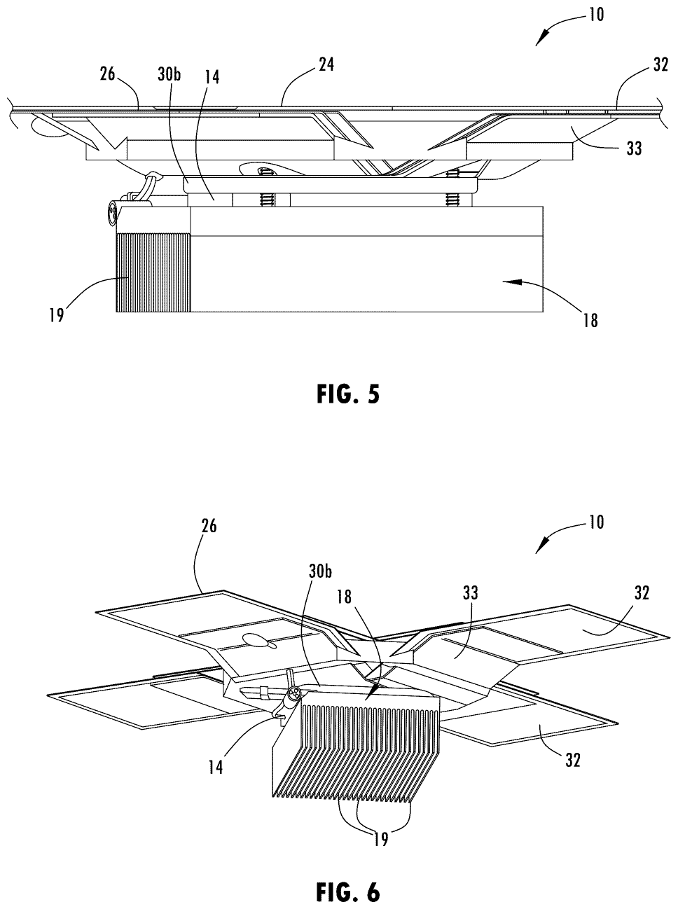

As shown in FIGS. 5-7, the graphene sheet material 26 of the composite structure 24 generally defines a first portion 32 that is extends over the outer surface of the foam structure 42 and a second portion 34 that is suspended inside the foam structure 42. The graphene material flexibly extends between the first portion 32 and the second portion 34, so as to define an intermediate portion 33 of the graphene material that flexes and bends to extend between the first and second portions 32, 34. The graphene sheet material 26 may form two overlapping rectangular pieces that define an X-shape, where the four extensions form the first portion 32 and the overlapping region at the center of the X-shape forms the second portion 34. As shown in FIG. 7, the second portion 34 of the flexible panel is thermally coupled with the electro-thermal conversion device 14 via clamping between the heat transfer blocks 30a, 30b. By recessing the connection of the second portion 34 inward from the outer surface of the foam structure 42, such as shown in FIG. 2, the electro-thermal conversion device 14 is generally not felt by a seated occupant. Also, the composite structure 24 that forms the flexible panel with the graphene material 26 is permitted to flex and conform to the compressed state of the seat under an occupant's weight.

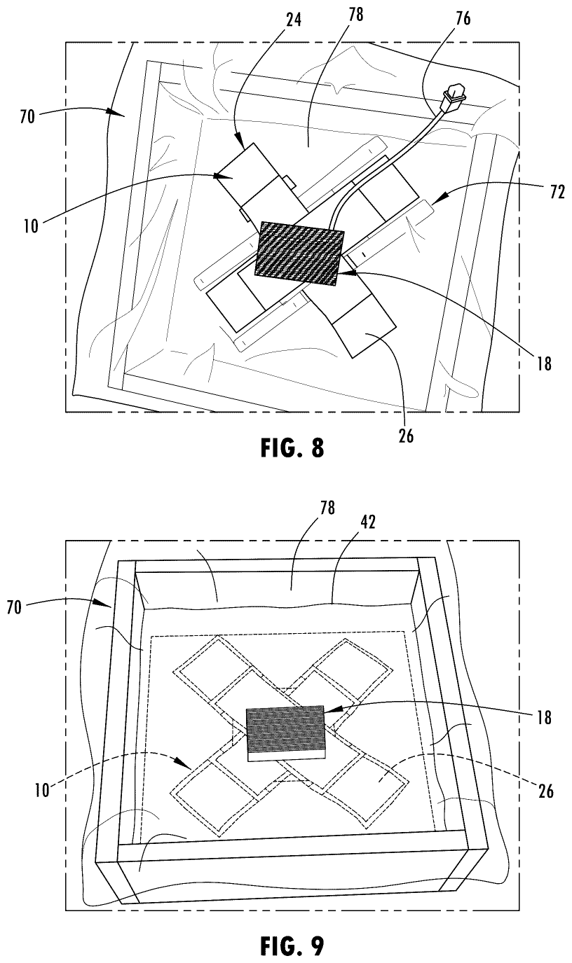

Referring to FIGS. 8 and 9, the thermal module 10 is provided in a mold 70 with the mold lined with a barrier film 78. The interior surface of mold cavity of the mold 70 is configured to define the desired shape, contour, and size of the resulting foam structure. For example, various shapes, predefined seams, borders, and thicknesses may be desired according to the relevant seat system 40, location of the device in the seat system, or application of the device in various types of vehicles, furniture, or garments. The mold 70 may include posts 72 or other stabilizing structures such as clips to keep the graphene sheet material 26 of the thermal module 10 in the desired position, such as shown in FIG. 8. As a liquid foam mixture is added to the mold 70, as shown in FIG. 9, the foam structure 42 begins to form and develop around the device 10.

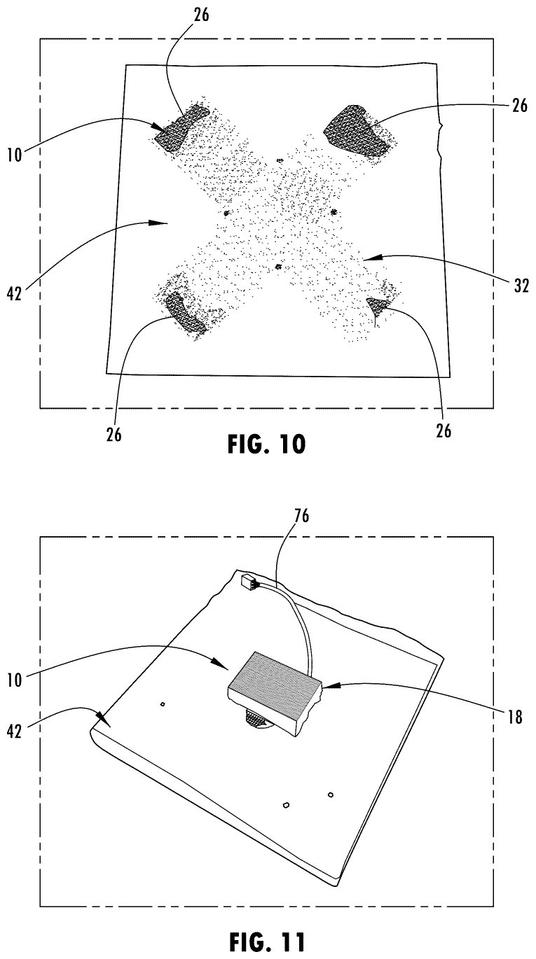

As also shown in FIGS. 9, the mold 70 is filled such as via pouring or injecting liquid foam mixture into the mold cavity having the composite structure 24 located in a desirable position and the electro-thermal conversion device 14 suspended to create the foam structure 42 in a manner that encapsulates the desired portions or entirety of the thermal module 10. For example, the foam structure 42 may be provided by injection molding or open molding to fill the mold and fill in cavities around the components of the thermal module 10. Once the foam 42 has expanded and generally solidified or cured, the foam structure 42 may be removed unitarily with the electro-thermal conversion device 14 from the mold and finished to the necessary shape, such as with any trimming or surface treatment. As shown in FIGS. 10-13, when the cured foam structure 42 is removed from the mold 70 together with the composite structure 24 located and the electro-thermal conversion device 14, the electro-thermal conversion device 14 is encapsulated in the foam structure 42 as a cushioned thermal module 10 that is substantially unitary and may be directly integrated into a seat system 40, such as a single, direct replacement for foam structures already provided in seat systems 40 without a heating or cooling device.

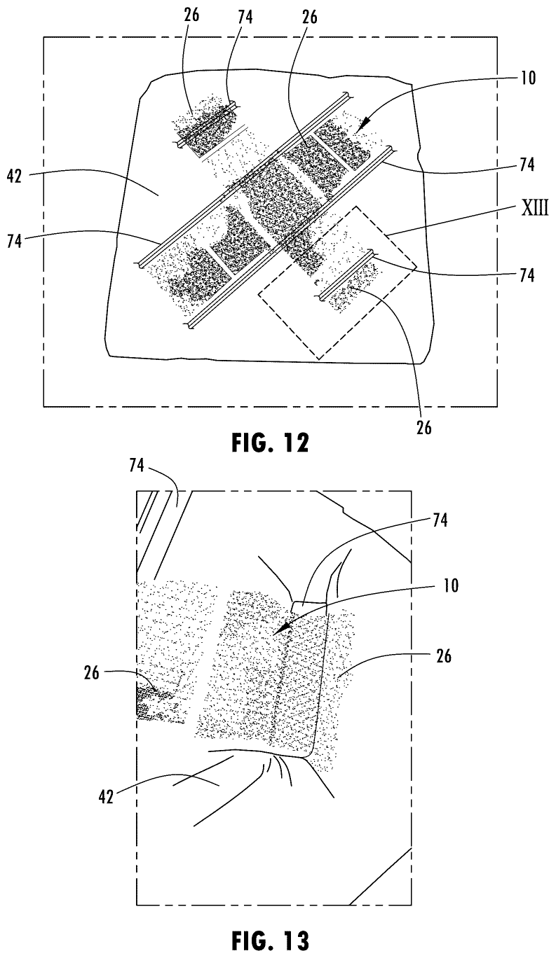

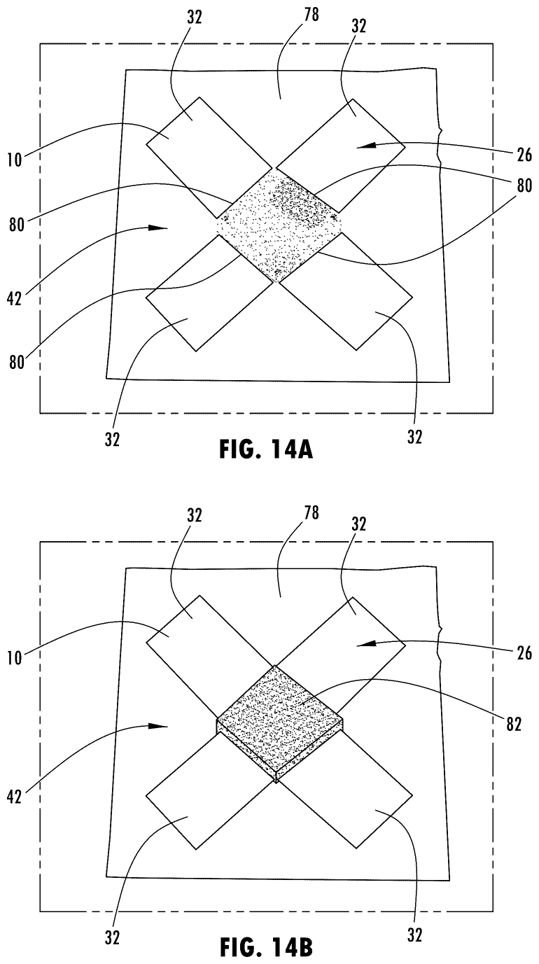

As further illustrated in FIG. 10, the foam structure 42 provides a generally flat top surface with the graphene sheet material 26 of the composite structure 24 partially exposed at the ends of the first portions 32, although parts of the first portion 32 of the graphene sheet material 26 are partially covered by a thin layer of foam. Such a configuration is generally shown in FIG. 2. In other examples, as shown in FIGS. 12, 14A, and 14B, less of the foam structure 42 is imparted on the first portion 32 of the graphene material 26, providing more direct exposure of the graphene material 26 to the supported occupant. In the example shown in FIGS. 12 and 13, the grooves 74 or depressions are imparted in the top surface of the foam 42 with the raised features 72 in the mold 70 (FIG. 8) in locations bordering and overlaying the graphene material 26. In providing the depressions at such locations, the graphene may be more prominent on the top surface than the surrounding foam material to encourage foam compression and sheet cover material accumulation to located in the grooves or depresses, ultimately facilitating more direct and uninterrupted contact between the user's body and the graphene material.

As shown in FIGS. 14A and 14B, additional examples have an opening or openings 80 in the barrier film 78 that is disposed in the mold cavity. The barrier film 78 is a flexible sheet material that is air permeable and configured to resist the passage of liquid foam during the formation of the foam structure 42. After forming the foam structure 42, the barrier film 78 is disposed over the seat support surface defined by the foam structure 42. As shown in FIGS. 2A and 14A, the composite structure 24 extends through the openings 80 in the barrier film 78 to define an exposed portion corresponding to the first portions 32 of the graphene material 26 that are positioned outside the foam structure 42 and overlaying the seat support surface with the barrier film 78 disposed therebetween. The barrier film 78 may be sealed around openings 80 against the composite structure 24 with tape or adhesive during forming the foam structure 42. Also, as shown in FIGS. 2B and 14B, the opening 80 may be around the connection of the composite structure 24 and the electro-thermal conversion device 14, such as between the lower thermal block 30a and the composite structure 24, such that generally the entire composite structure 24 is disposed outside of and overlaying the outer surface of the foam structure 42. In this example, the upper thermal block 30b is otherwise exposed at bottom of a rectangular recess in the seat surface defined by the foam structure 42. To provide cushioning in this recess, a foam piece 82 may be placed in the recess and covered with the seat cover 44 to provide a generally uninterrupted and flush seat surface 12. It is also contemplated that the foam piece 82 may have a different density or thermal conductivity from the foam structure 42 to more efficiently transfer heat to the interfacing portion of the seat surface 12.

Referring to FIGS. 15A-15C, foam structures may be provided in various examples according to different applications and desires for the seat system. In the example shown in FIG. 15A, a seat system 140 may include a thermal device 110 with a foam structure 142 encapsulating a protective case 160 having a thermal transfer block 130, a thermoelectric device 114, a heat sink 118, and a blower 120. As shown, the foam 142 is cast directly to a graphene layer 126 that is positioned generally outside of the foam structure 142 with the graphene layer 126 disposed against the outside surface of the foam structure. The protective case 160 encased in the foam structure may be a protection layer such as a plastic case. The protective case 160 may include intake and outlet vents for air intake to the blower 120 and for an exhaust 158 at the heat sink 120 such as described above in FIGS. 3 and 4. During molding, the openings 156, 158 may be closed, such as with a temporary closure, to prevent the foam structure 142 from filling and closing the air channel. In said example, the device 110 and foam structure 142 are provided in the seat system 140. As the graphene layer 126 is positioned outside of the foam structure 142, the seat system 140 may include an additional thin layer of foam or similar material provided between the graphene 126 and a seat surface 112 to protect the graphene from a user and to prevent a user from feeling the rigidity of the graphene 126.

In the example shown in FIG. 15B, a seat system 240 may include a thermal device 210 with a foam structure 242 encapsulating the protective case 260 and in which a graphene layer 226 is also suspended in the foam 242. In this example, the device 210 and foam structure 242 may be provided in the seat system 240 without requiring an additional foam or similar layer between the graphene 226 and a seat surface 212 to protect the device 210 and provide a comfortable surface for a user.

In the example shown in FIG. 15C, a seat system 340 may include a thermal device 310 encapsulated in a foam structure 342 having a first area 366 and a second area 368. The first area 366 may include a foam having a first density. The second area 368 may include a foam having a second density. As shown, the first area 366 is generally disposed approximate the top of the form layer 342 and is configured as a comfort layer for a user. The first density has a lower density than the second foam density to provide a foam which provides more movement and comfort when a user occupies the seat system 340. The second density is of a higher density such that it is configured not to move with a user occupying the seat system 340 to provide a stable structure around the heating and cooling device 310 and to protect the components. As further shown in FIG. 10C, a transition point 367 between the first area 366 and the second area 368 may be between the protective case 360 and the graphene layer 326. In other examples, the transition point may be located at a different position in the foam structure 342. Further, in other examples, more than one transition point may exist. For example, the second density foam may be sandwiched between two layers of the first density foam, a first layer extending across the top of the foam structure and a second layer extending across the bottom of the foam structure.

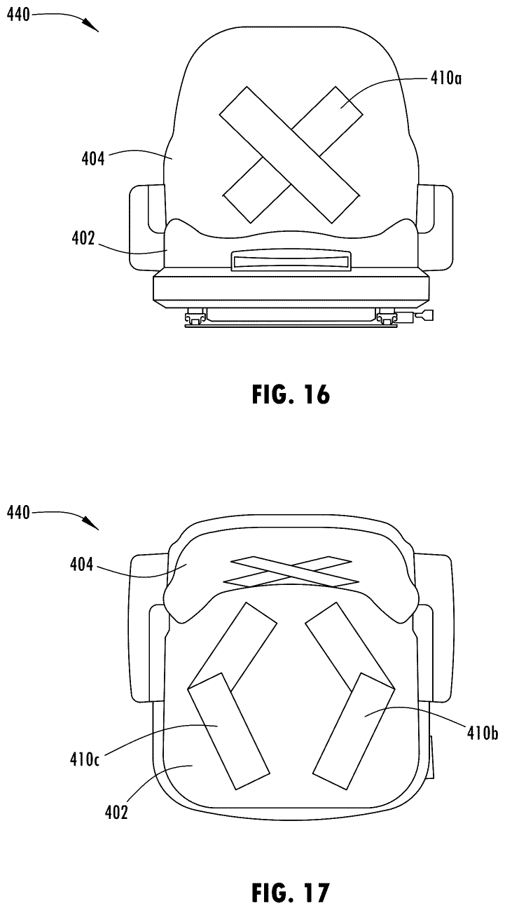

Referring to FIGS. 16 and 17, a seat system 440 may include a seat cushion 402 and a seat back 404. In some examples, the seat system 440 may provide a packaging space which is not sufficient for a thermal engine, for example, the seat cushion 402 may not provide enough clearance for a thermal device as described above to fit in a central location of the seat cushion. In this example, a first thermal device 410a may be provided in the seat back 404 in a configuration as described above in at least FIGS. 2-7. The seat cushion 402 may include a second thermal device 410b and a third thermal device 410c such that the seat cushion 402 includes two electro-thermal conversion devices. In examples, the first device 410a may operate independently from the second and third devices 410b, 410c so a user can choose to provide heating or cooling to one or both of the seat cushion or the seat back. As illustrated in FIG. 17, the seat cushion 402 may include the second device 410b on a first side of the seat cushion 402 where the clearance is larger, and the third device 410c on a second side of the seat cushion 402, opposite the first device 410b. In examples, the second and third devices 410b, 410c may operate dependently such that controls for the first and second devices 410b, 410c are connected. In other examples, the first and second thermal engines may operate independently. In further examples, more or less devices may be places in various locations as required for the desired seat system configuration.

For purposes of this disclosure, the term “coupled” (in all of its forms, couple, coupling, coupled, etc.) generally means the joining of two components directly or indirectly to one another. Such joining may be stationary in nature or movable in nature; may be achieved with the two components and any additional intermediate members being integrally formed as a single unitary body with one another or with the two components; and may be permanent in nature or may be removable or releasable in nature, unless otherwise stated.

Also for purposes of this disclosure, the articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” “inner,” “outer” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A cushioned thermal module for a seat, the cushioned thermal module comprising:
an electro-thermal conversion device configured to move heat to or from a conductive surface in response to applying a low voltage current;
a composite structure thermally coupled with the conductive surface of the electro-thermal conversion device, the composite structure comprising a graphene material; and
a foam structure encasing the electro-thermal conversion device and defining a seat support surface,
wherein the composite structure is at least partially disposed over the seat support surface, and
wherein the composite structure is configured to conductively transfer heat between the electro-thermal conversion device and a seat cover disposed over the seat support surface.

2. The cushioned thermal module of claim 1, wherein the composite structure comprises a flexible panel having a first portion disposed over the seat support surface and a second portion suspended inside the foam structure.

3. The cushioned thermal module of claim 2, wherein the graphene material flexibly extends between the first portion and the second portion of the flexible panel.

4. The cushioned thermal module of claim 3, wherein the second portion of the flexible panel is thermally coupled with the conductive surface.

5. The cushioned thermal module of claim 1, wherein the composite structure is thermally coupled with the conductive surface via a heat transfer block.

6. The cushioned thermal module of claim 1, wherein the foam structure is molded around the electro-thermal conversion device.

7. The cushioned thermal module of claim 1, wherein a protective cover surrounds at least a portion of the electro-thermal conversion device and is located between the foam structure and the portion of the electro-thermal conversion device.

8. The cushioned thermal module of claim 7, wherein the protective cover surrounds a blower and a heat sink, the blower configured to direct air over the heat sink.

9. The cushioned thermal module of claim 8, wherein the heat sink is coupled to the electro-thermal conversion device to disperse heat.

10. The cushioned thermal module of claim 9, wherein the foam structure includes an air channel from an outer surface of the foam structure to the protective cover, and wherein the air channel is aligned with at least one of an inlet vent and an outlet vent of the protective cover.

11. The cushioned thermal module of claim 1, wherein a barrier film is disposed over the seat support surface and is configured to prevent the foam structure from covering at least a portion of the composite structure that is disposed over the seat support surface.

12. The cushioned thermal module of claim 11, wherein the composite structure extends through an opening in the barrier film to define an exposed portion that is positioned outside the foam structure.

13. The cushioned thermal module of claim 11, wherein the barrier film is a flexible sheet material that is air permeable and is configured to resist the passage of liquid foam during the formation of the foam structure.

14. The cushioned thermal module of claim 1, wherein the electro-thermal conversion device is provided in at least one of a seat back and a seat cushion of a seating system.

15. The cushioned thermal module of claim 1, wherein the foam structure includes a first section of a first foam density and a second section of a second foam density, and wherein the electro-thermal conversion device is positioned in the first section and the graphene material is positioned in the second section.

16. A seating system, comprising:
a seat frame;
a cushioned thermal module supported by the seat frame, the cushioned thermal module comprising:
an electro-thermal conversion device configured to move heat to or from a conductive surface in response to applying a low voltage current;
a foam structure encasing the electro-thermal conversion device and defining a seat support surface; and
a graphene structure thermally coupled with the conductive surface of the electro-thermal conversion device and at least partially disposed over the seat support surface; and
a seat cover disposed over the seat surface and the graphene structure to define a user support surface, wherein the graphene structure is configured to conductively transfer heat between the electro-thermal conversion device and the seat cover.

17. The seating system of claim 16, wherein the seat frame includes a seat pan that supports the cushioned thermal module as a seat cushion.

18. The seating system of claim 17, wherein the seat frame includes a seat back that supports a second cushioned thermal module as a back cushion.

19. The seating system of claim 18, wherein the first cushioned thermal module and the second cushioned thermal module are connected to a common controller and are configured to operate independently.

20. A method for forming a cushioned thermal module for a seat, the method comprising:
providing an electro-thermal conversion device configured to move heat to or from a conductive surface in response to applying a low voltage current;
positioning a first portion of a flexible graphene structure at a bottom surface of a mold cavity, wherein a second portion of the flexible graphene structure is thermally coupled with the conductive surface of the electro-thermal conversion device;
suspending the electro-thermal conversion device above the bottom surface of the mold cavity;
pouring a liquid foam mixture into the mold cavity to at least partially encase the electro-thermal conversion device; and
curing the liquid foam mixture in the mold cavity to form a foam structure that defines a seat support surface with the first portion of the flexible graphene structure is at least partially disposed over the seat support surface.
